(19) United States
(12) Patent Application Publication
(10) Pub. No.: US 2024/0332842 A1
(43) Pub. Date: Oct. 3, 2024

(54) CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Takanori OSAWA, Osaka (JP); Keigo TAKAHASHI, Osaka (JP)

(21) Appl. No.: 18/610,702

(22) Filed: Mar. 20, 2024

(30) Foreign Application Priority Data
Mar. 30, 2023 (JP) 2023-055906

(51) Int. Cl. H01R 13/02; H01R 13/502; H01R 13/52; H01R 13/639; H01R 103/00

(52) U.S. Cl. CPC H01R 13/02; H01R 13/502; H01R 13/5208; H01R 13/5202; H01R 13/639; H01R 2103/00

(57) ABSTRACT

A dielectric 30 to be accommodated into a module accommodation chamber (11, 131) includes a first cavity 46 and a second cavity 31 located below the first cavity 46. A first wire (90, 180) drawn out into a routing space (12, 132) from the rear end of the first cavity 46 includes a first bent portion (91, 181), and a second wire (100, 190) drawn out into the routing space (12, 132) from the rear end of the second cavity 31 includes a second bent portion (101, 191) bent in the same direction as the first bent portion (91, 181). The rear end of the first cavity 46 is located behind that of the second cavity 31.

### CROSS-REFERENCE TO RELATED APPLICATIONS

This application is based on and claims priority from Japanese Patent Application No. 2023-055906, filed on Mar. 30, 2023, with the Japan Patent Office, the disclosure of which is incorporated herein in its entirety by reference.

### TECHNICAL FIELD

The present disclosure relates to a connector.

### BACKGROUND

Japanese Patent Laid-open Publication No. 2020-140803 discloses a connector provided with a housing and a terminal module to be accommodated into the housing. The terminal module is provided with a plurality of terminal fittings, wires crimped to the respective terminal fittings, and a dielectric including a plurality of terminal accommodation chambers for accommodating the plurality of terminal fittings. For example, the dielectric includes a total of four terminal accommodation chambers (hereinafter, also referred to as cavities) for accommodating the terminal fittings in two upper and lower rows. The wire is pulled out from the rear end of each cavity into a wire accommodation chamber (hereinafter, also referred to as a routing space) of the housing, and extends straight along a terminal insertion direction in the wire accommodation chamber. A space formed in the housing to allow the insertion of the terminal fittings and the wires therethrough has a linear shape.

### SUMMARY

To meet a demand for the length reduction of connectors, connectors in which wires are bent and routed inside a housing have been, for example, developed in recent years. However, if the wires are bent in a limited space, there is a concern that a power wire and a signal wire easily approach, for example, if the wires include the power wire and the signal wire. If the power wire and the signal wire approach, transmission characteristics may be degraded.

The present disclosure is directed to a connector with a housing formed with a module accommodation chamber and a routing space communicating with a rear end part of the module accommodation chamber, and a terminal module to be inserted into the module accommodation chamber from behind, the terminal module including a first wire, a first terminal fitting fixed to the first wire, a second wire, a second terminal fitting fixed to the second wire and a dielectric to be accommodated into the module accommodation chamber, the dielectric including a first cavity for accommodating the first terminal fitting and a second cavity located below the first cavity for accommodating the second terminal fitting, the first wire drawn out into the routing space from a rear end of the first cavity including a first bent portion by bending a tip part in a draw-out direction in a direction intersecting an insertion direction of the dielectric into the module accommodation chamber in the routing space, the second wire drawn out into the routing space from a rear end of the second cavity including a second bent portion bent in the same direction as the first bent portion, and the rear end of the first cavity is located behind that of the second cavity.

A connector of the present disclosure can prevent the degradation of transmission characteristics due to the mutual approach of bent and routed wires.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view of a connector in a first embodiment.

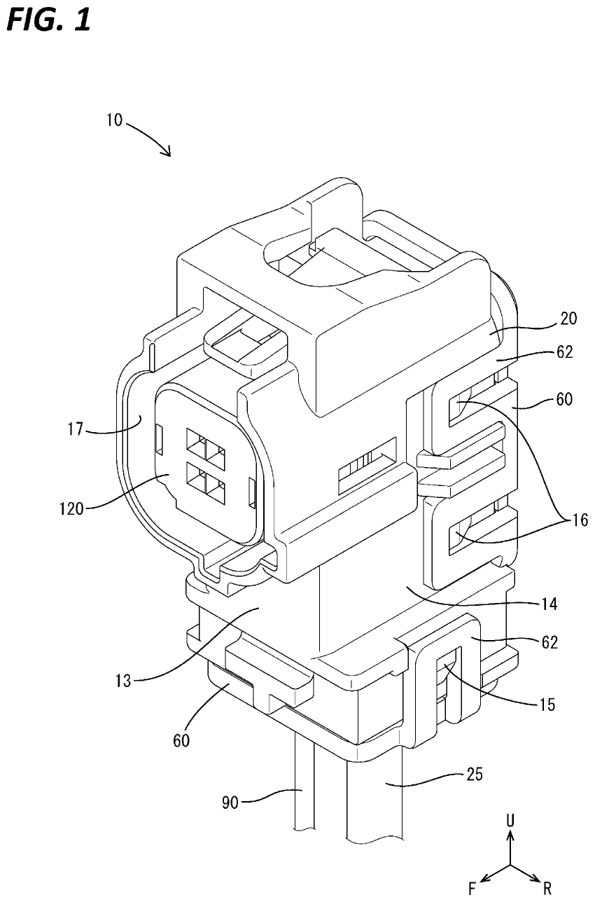

FIG. 2 is an exploded perspective view of the connector in the first embodiment.

FIG. 3 is a side view in section showing the routing of first wires and second wires inside the connector of the first embodiment.

FIG. 4 is a back view in section of the connector in the first embodiment.

FIG. 5 is a plan view in section of a rubber plug part in the first embodiment.

FIG. 6 is a perspective view of a connector in a second embodiment.

FIG. 7 is an exploded perspective view of the connector in the second embodiment.

FIG. 8 is a bottom view in section showing the routing of first wires and second wires inside the connector of the second embodiment.

FIG. 9 is a back view in section of the connector in the second embodiment.

FIG. 10 is a side view in section of a rubber plug part in the second embodiment.

FIG. 11 is an exploded perspective view, partially cut away, of a terminal module in the first and second embodiments.

FIG. 12 is a section showing a state where a second terminal fitting is erroneously inserted in a first cavity in the first and second embodiments.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### DESCRIPTION OF EMBODIMENTS OF PRESENT DISCLOSURE

(1) The connector of the present disclosure is provided with a housing formed with a module accommodation chamber and a routing space communicating with a rear end part of the module accommodation chamber, and a terminal module to be inserted into the module accommodation chamber from behind. The terminal module includes a first wire, a first terminal fitting fixed to the first wire, a second wire, a second terminal fitting fixed to the second wire and a dielectric to be accommodated into the module accommodation chamber. The dielectric includes a first cavity for accommodating the first terminal fitting and a second cavity located below the first cavity for accommodating the second terminal fitting. The first wire drawn out into the routing space from a rear end of the first cavity includes a first bent portion by bending a tip part in a draw-out direction in a direction intersecting an insertion direction of the dielectric into the module accommodation chamber in the routing space. The second wire drawn out into the routing space from a rear end of the second cavity includes a second bent portion bent in the same direction as the first bent portion. The rear end of the first cavity is located behind that of the second cavity.

Since the rear end of the first cavity is located behind that of the second cavity, the first wire including the first bent portion and the second wire including the second bent portion can be easily routed while being spaced apart in a front-rear direction in the routing space. In this way, the degradation of transmission characteristics due to the approach of the first and second wires can be suppressed in the housing. Note that, in this specification, the “same direction” means not only perfectly the same direction, but also slightly deviated directions within a range that the above functions and effects are achieved even without being perfectly the same.
(2) In the connector of (1), the second cavity is preferably shorter in the front-rear direction than the first terminal fitting.

According to this configuration, if an attempt is made to accommodate the first terminal fitting into the second cavity, a part of the first terminal fitting protrudes from the second cavity, wherefore the first terminal fitting can be prevented from being erroneously accommodated into the second cavity.
(3) In the connector of (1) or (2), preferably, the first wire extends downward from the first bent portion in the routing space, the second wire extends from the second bent portion in the same direction as the first bent portion in the routing space, and the first and second wires are routed while being spaced apart in a lateral direction in the routing space.

According to this configuration, the first and second wires are routed while being spaced apart not only in the front-rear direction, but also in the lateral direction. A large interval between the first and second wires can be ensured in the routing space as compared to the case where the first and second wires are routed without being spaced apart in the lateral direction. Therefore, the degradation of transmission characteristics can be effectively suppressed even without increasing a dimension in the front-rear direction of the routing space.
(4) In the connector of (3), preferably, a resilient member is further provided which closes an opening of an end part opposite to the module accommodation chamber in the routing space, the resilient member includes a first sealing hole, the first wire being passed through the first sealing hole, and a second sealing hole, the second wire being passed through the second sealing hole, and the first and second sealing holes are arranged at an interval from each other in the lateral direction.

According to this configuration, since the first and second wires are held in such a positional relationship as to be laterally separated in the routing space by inserting the first and second wires through the first and second sealing holes, the degradation of transmission characteristics due to the approach of the first and second wires is prevented.
(5) In the connector of (1) or (2), preferably, the first wire laterally extends from the first bent portion in the routing space, the second wire extends from the second bent portion in the same direction as the first bent portion in the routing space, and the first and second wires are routed while being spaced apart in a vertical direction in the routing space.

According to this configuration, the first and second wires are routed while being spaced apart not only in the front-rear direction, but also in the vertical direction. A large interval between the first and second wires can be ensured in the routing space as compared to the case where the first and second wires are not spaced apart in the vertical direction. Therefore, the degradation of transmission characteristics can be effectively suppressed even without increasing a dimension in the front-rear direction of the routing space.
(6) In the connector of (5), a resilient member is further provided which closes an opening of an end part opposite to the module accommodation chamber in the routing space, the resilient member includes a first sealing hole, the first wire being passed through the first sealing hole, and a second sealing hole, the second wire being passed through the second sealing hole, and the first and second sealing holes are arranged at an interval from each other in the vertical direction.

According to this configuration, since the first and second wires are held in such a positional relationship as to be vertically separated in the routing space by inserting the first and second wires through the first and second sealing holes, the degradation of transmission characteristics due to the approach of the first and second wires is prevented.

### DETAILS OF EMBODIMENTS OF PRESENT DISCLOSURE

Embodiments of the present disclosure are described below with reference to the drawings. The present disclosure is not limited to these illustrations, but is represented by claims and intended to include all changes in the scope of claims and in the meaning and scope of equivalents.

A “front side,” an “upper side” and a “right side” are denoted by “F,” “U” and “R.”

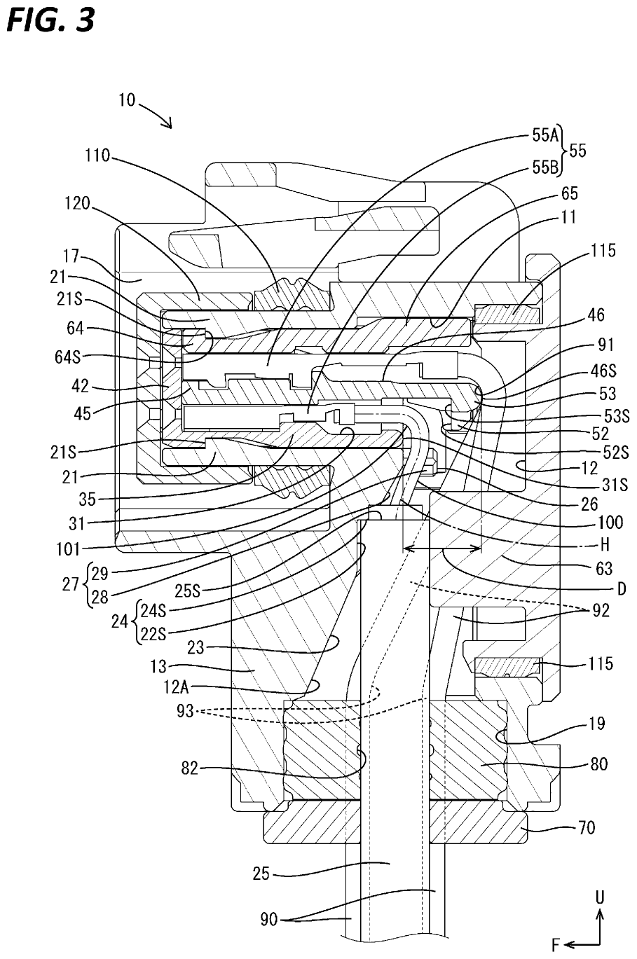

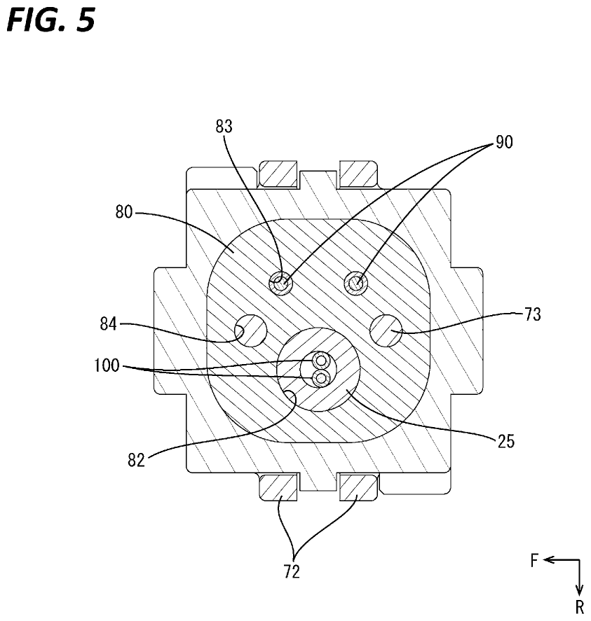

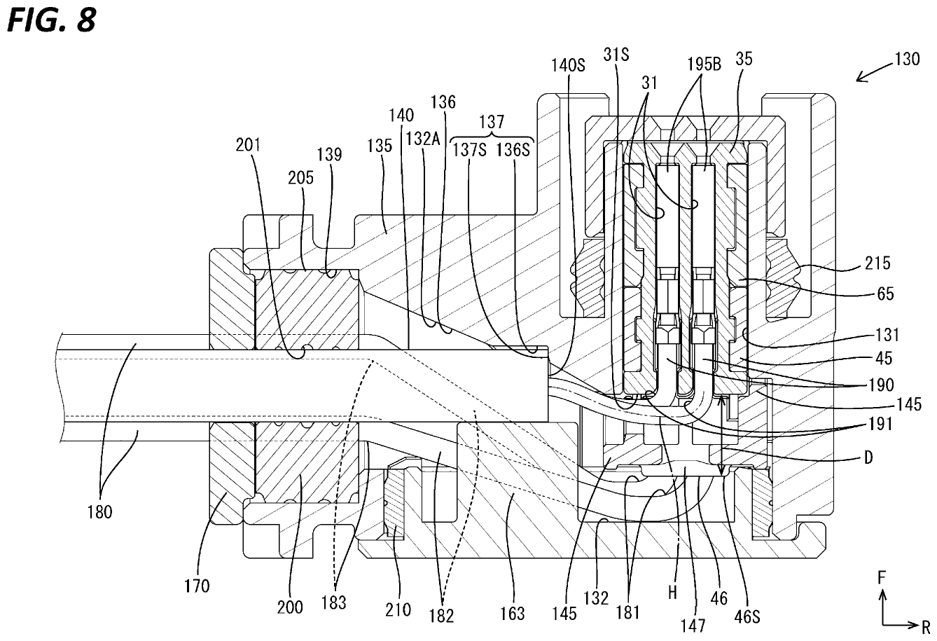

A surface side of a connector (10, 130) to be connected to a mating connector (not shown) is referred to as a front side concerning a front-rear direction. A vertical direction is based on a vertical direction of each figure except FIGS. 5 and 8. A lateral direction is based on a lateral direction of each figure except FIGS. 3, 10 and 12.

### First Embodiment

### [Connector 10]

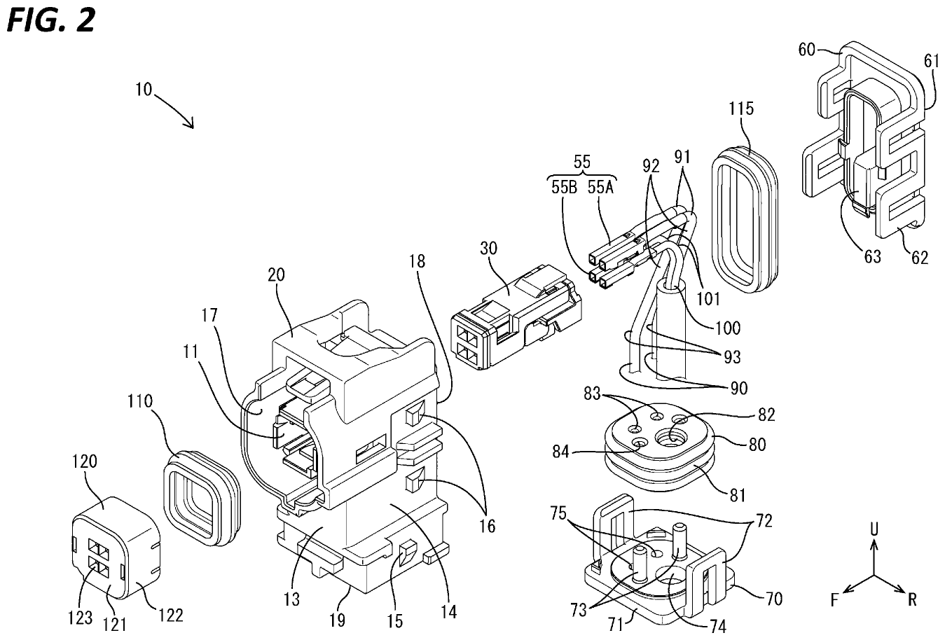

As shown in FIG. 2, a connector 10 of a first embodiment is provided with a housing 20, a terminal module 30A, a back surface cover 60 for closing the housing 20 from a back side, a lower surface cover 70 for closing the housing 20 from below, a resilient member 80 (hereinafter, also referred to as a rubber plug), first wires 90, second wires 100, a front sealing ring 110, a back surface sealing ring 115, a front retainer 120.

The housing 20 is L-shaped in a side view. The housing 20 includes a module accommodation chamber 11 and a routing space 12 communicating with a rear end part of the module accommodation chamber 11. The module accommodation chamber 11 extends in the front-rear direction in the housing 20. The routing space 12 extends downward from a rear part of the module accommodation chamber 11. The outer surface of the housing 20 is covered by a front wall portion 13 and side wall portions 14. Lower lock receiving portions 15 to be fit to the lower surface cover 70 are formed in lower parts of the side wall portions 14. Upper lock receiving portions 16 to be fit to the back surface cover 60 are formed in central parts and upper parts of the side wall portions 14. A front surface opening 17 is formed in the front surface of an upper part of the housing 20. A back surface opening 18 is formed over an entire region in the back surface of the housing 20. A lower surface opening 19 is formed in the lower surface of the housing 20.

As shown in FIG. 3, the module accommodation chamber 11 is an internal space formed in the front-rear direction in an upper end part of the housing 20. The terminal module 30A is inserted into the module accommodation chamber 11 from behind. The front end of the module accommodation chamber 11 is open. Upper and lower inner walls of a front end part of the module accommodation chamber 11 include resiliently deformable plate-like portions 21. A front end part of the plate-like portion 21 is gently inclined to become narrower toward the front. The plate-like portion 21 is resiliently deformable outward by being pressed from behind. A front end surface 21S of an inclined part of the plate-like portion 21 functions as a locking end surface to be locked to a lock portion 64 of the terminal module 30A to be described later. The front end surface 21S of the inclined part of the plate-like portion 21 is a surface perpendicular to an accommodation direction of the terminal module 30A.

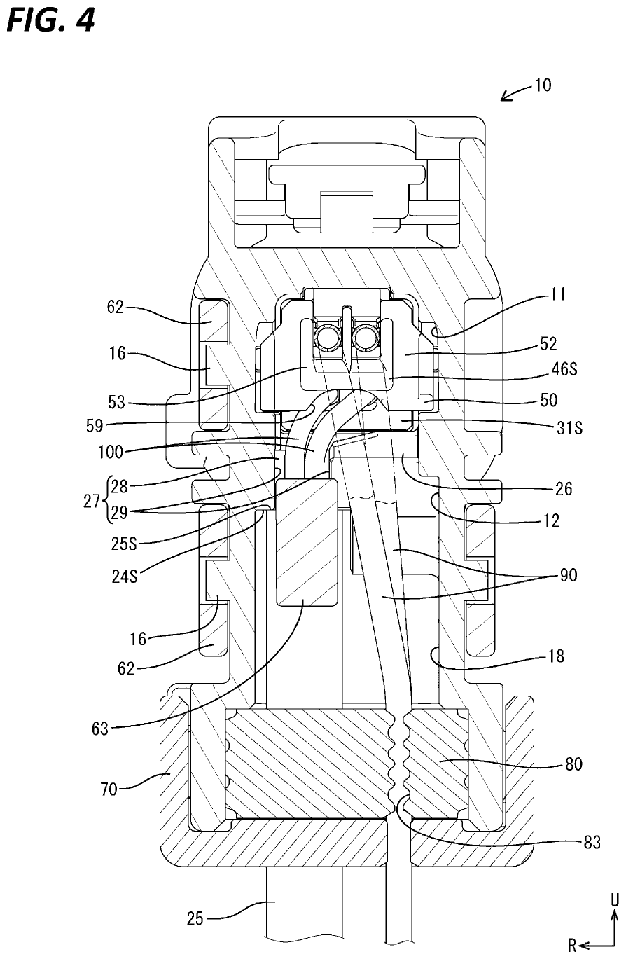

The routing space 12 is an internal space formed in the vertical direction in a rear part inside the housing 20. The first wires 90 to be described later and front end regions of the second wires 100 are accommodated in the routing space 12. The front wall portion 13 of the routing space 12 has an overhanging inclined surface 23 inclined to widen the routing space 12 in the front-rear direction toward a lower side. The inclined surface 23 includes a recessed step portion 24 formed by a restricting surface 24S perpendicular to the vertical direction and a wall surface 22S perpendicular to the front-rear direction. An end surface 25S of a sheath 25 of the second wires 100 is in contact with the restricting surface 24S perpendicular to the vertical direction. In a plan view of the housing 20, the step portion 24 is arranged at an intermediate position in the front- rear direction between inner walls of a lower end part of the routing space 12. As shown in FIG. 4, a protrusion 26 extending rearward is formed on a left side of an upper part of the front wall portion 13 of the routing space 12. The protrusion 26 has a trapezoidal shape by cutting off a right upper part of a rectangular shape when viewed from behind. An edge part of the protrusion 26 is tapered. A path restricting portion 27 is formed on a right side of the upper part of the routing space 12. The path restricting portion 27 is defined by a guiding inclined surface 28 inclined forward and a pair of restricting walls 29 extending rearward from left and right edges of the guiding inclined surface 28.

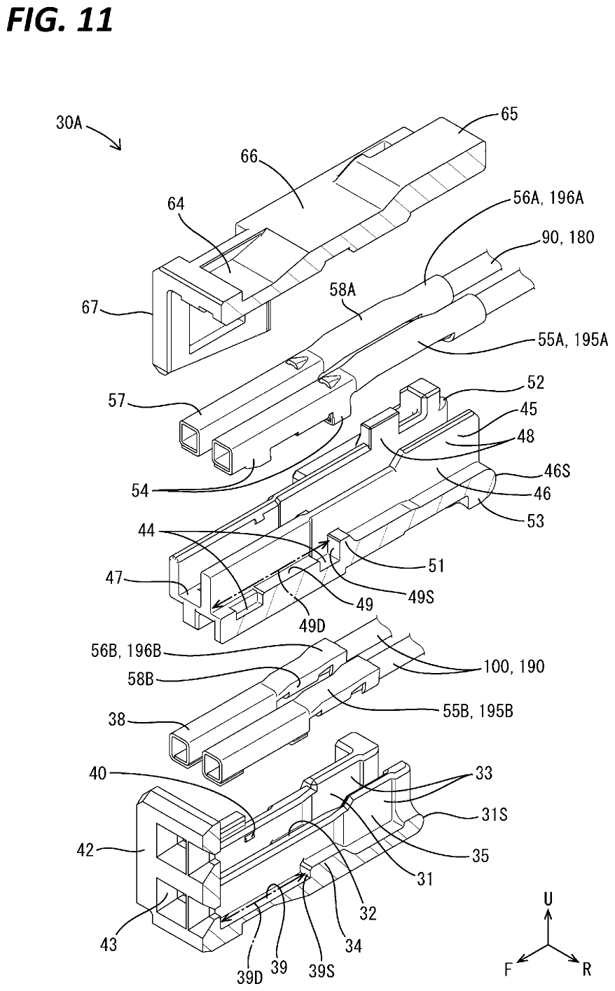

As shown in FIG. 11, the terminal module 30A includes the first wires 90, first terminal fittings 55A, the second wires 100, second terminal fittings 55B and a dielectric 30. The dielectric 30 includes, for example, a lower dielectric 35, a middle dielectric 45 and a dielectric cover 65.

The lower dielectric 35 forms a lower part of the dielectric 30 and accommodates the second terminal fittings 55B. The lower dielectric 35 includes second cavities 31 for accommodating the second terminal fittings 55B between both ends in the front-rear direction. The second cavity 31 is a rectangular space long in the front-rear direction and formed by a lower bottom wall 32 and lower inner walls 33 extending upward from left and right end parts of the lower bottom wall 32. A front end part of the lower bottom wall 32 includes a second engaging recess 39 having a longitudinal rectangular shape when viewed from above for accommodating a second terminal body portion 38 of the second terminal fitting 55B. A second projection 34 raised upward into a step shape from the lower bottom wall 32 is formed in a rear part of the second engaging recess 39. A rear end surface 39S of the second engaging recess 39 is made perpendicular to the lower bottom wall 32 by the second projection 34. Two second cavities 31 are bilaterally symmetrically formed in the lower dielectric 35. The front ends of the second cavities 31 of the lower dielectric 35 are formed with a rectangular plate-like inserting portion 42 extending perpendicularly from the front edge of the lower bottom walls 32. The inserting portion 42 is formed with four insertion holes 43 for allowing the insertion of mating male terminals (not shown). The lower dielectric 35 includes a lower engaging portion 40.

The middle dielectric 45 forms a middle part of the dielectric 30 and accommodates the first terminal fittings 55A. The middle dielectric 45 includes first cavities 46 for accommodating the first terminal fittings 55A between both ends thereof in the front-rear direction. The middle dielectric 45 includes side portions 52 and a lower portion 53 in a rear end part.

The first cavity 46 is a rectangular space long in the front-rear direction and formed by a middle bottom wall 47 and middle side walls 48 extending upward from left and right end parts of the middle bottom wall 47. The middle bottom wall 47 is formed with a first engaging recess 49 for accommodating a first terminal body portion 57 of the first terminal fitting 55A. Both front and rear end parts of the first engaging recess 49 include first positioning recesses 44 for accommodating first positioning projections 54 of the first terminal body portion 57. A first projection 51 raised upward into a step shape from the middle bottom wall 47 is formed behind the first positioning recess 44 on a rear end side. A rear end surface 49S of the first engaging recess 49 is perpendicular to the bottom surface of the first positioning recess 44. A vertical height of the rear end surface 49S of the first engaging recess 49 is larger than that of the rear end surface 39S of the second engaging recess 39. A height from the lower end of the first positioning projection 54 to the upper end surface of the first terminal body portion 57 is larger than that from the lower end surface to the upper end surface of a front end part of the second terminal body portion 38. A length 49D in the front-rear direction of the first engaging recess 49 is longer than a length 39D in the front-rear direction of the second engaging recess 39. Two first cavities 46 are bilaterally symmetrically formed in the middle dielectric 45.

As shown in FIG. 4, the side portions 52 are parts for covering both outer side surfaces of the first cavities 46 in a rear end part. A lower end part of the side portion 52 for covering a left side of the first cavity 46 has a cover inclined surface 50 inclined forward. As shown in FIG. 3, the lower portion 53 is a part for supporting the first cavities 46 from below in the rear end part. When viewed from behind, the lower ends of the side portions 52 are located further below the lower end of the lower portion 53. A lower central part of the rear end of the lower portion 53 forms a cover recess 59 recessed to be curved upward to route the second wires 100 in front of the first wires 90 in the routing space 12. As shown in FIG. 3, the lower portion 53 projects rearward when viewed laterally. The rear end of the lower portion 53 has an arcuate shape in a side view. As shown in FIG. 3, the lower end of a front end surface 53S of the lower portion 53 is formed below the upper ends of the second wires 100. The lower end of a front end surface 52S of the side portion 52 is formed below the upper ends of the second wires 100. The rear end of the lower portion 53 is the rear ends of the first cavities 46. With the lower dielectric 35 and the middle dielectric 45 fit and fixed, rear end surfaces 46S of the first cavities 46 are located behind rear end surfaces 31S of the second cavities 31. The rear end surfaces 46S of the first cavities 46 and the rear end surfaces 31S of the second cavities 31 are arranged at an interval D in the front-rear direction. Note that the front ends of the first cavities 46 and those of the second cavities 31 are, for example, at the same position in the front-rear direction.

The dielectric cover 65 forms an upper part of the dielectric 30 and covers the lower dielectric 35 and both side surfaces and an upper side of the middle dielectric 45. An outer side of the dielectric cover 65 is formed by an upper surface cover portion 66 and side surface cover portions 67 and open on a front side. The dielectric cover 65 includes first engaging portions (not shown) to be engaged with the middle dielectric 45 on inner sides of both side surfaces of a rear side, second engaging portions (not shown) to be engaged with the lower dielectric 35 on inner sides of both side surfaces of a front side and the lock portions 64 to be fit to the plate-like portions 21 of the housing 20 in the module accommodation chamber 11 on the upper surface of the front side.

The first terminal fittings 55A and the second terminal fittings 55B are collectively called terminal fittings 55. Each terminal fitting 55 is a single component formed, such as by bending a metal plate material. As shown in FIG. 11, each terminal fitting 55 has a shape elongated in the front-rear direction as a whole. An annular crimping portion is formed in a rear end region of each terminal fitting 55. The first terminal fitting 55A is fixed to the first wire 90 by crimping a first crimping portion 56A of the first terminal fitting 55A to a front end part of the first wire 90. The second terminal fitting 55B is fixed to the second wire 100 by crimping a second crimping portion 56B of the second terminal fitting 55B to a front end part of the second wire 100. The first terminal body portion 57 in the form of a rectangular tube is formed in a front end region of the first terminal fitting 55A. The second terminal body portion 38 in the form of a rectangular tube is formed in a front end region of the second terminal fitting 55B. A resilient contact piece (not shown) is formed in each terminal body portion 57, 38. The connector 10 is electrically connected to the mating connector by bringing mating male terminals (not shown) of the mating connector and the respective resilient contact pieces into contact.

The first terminal fitting 55A is accommodated into the first cavity 46. The first terminal fitting 55A is, for example, a terminal to be connected to the Ethernet. The Ethernet (registered trademark) is computer network standards and used in a LAN (Local Area Network) or the like. The first terminal body portion 57 is, for example, in the form of a rectangular tube. The first terminal body portion 57 includes the first positioning projections 54 projecting downward at two positions on both sides in the front-rear direction. The first positioning projections 54 are parts to be engaged with the first engaging recess 49 of the first cavity 46. The first terminal fitting 55A includes a first connecting portion 58A connecting the upper ends of the first crimping portion 56A and the first terminal body portion 57 to each other. The first terminal fitting 55A is longer in the front-rear direction than the second terminal fitting 55B. The first terminal fitting 55A is longer in the front-rear direction than the second cavity 31. A length in the front-rear direction of the first terminal body portion 57 is longer than the length 39D in the front-rear direction of the second engaging recess 39.

The second terminal fitting 55B is accommodated into the second cavity 31. The second terminal fitting 55B is, for example, a terminal to be connected to an in-vehicle communication line. The second terminal body portion 38 is, for example, in the form of a rectangular tube. The second crimping portion 56B has, for example, an annular shape. The second terminal fitting 55B includes a second connecting portion 58B connecting the upper ends of the second terminal body portion 38 and the second crimping portion 56B to each other. An intermediate part in the front-rear direction of the second connecting portion 58B is thicker in the vertical direction than other parts.

The second connecting portion 58B is thicker in the vertical direction than the first connecting portion 58A. The second connecting portion 58B is shorter in the front-rear direction than the first connecting portion 58A. The second crimping portion 56B is shorter in the front-rear direction than the first crimping portion 56A. A downward projection dimension of the first positioning projection 54 is longer than a vertical dimension of the rear end surface 39S of the second engaging recess 39. The second terminal body portion 38 is shorter in the front-rear direction than the first terminal body portion 57.

The first wires 90 extend one by one from the two first cavities 46 formed in the middle dielectric 45. The first wires 90 extending from the rear ends of the first terminal fittings 55A, i.e. extending from the rear ends of the first cavities 46, are drawn out into the routing space 12. As shown in FIG. 3, the first wire 90 drawn out into the routing space 12 includes a first bent portion 91 by bending a tip part in a draw-out direction in a direction intersecting an insertion direction of the dielectric 30 into the module accommodation chamber 11 in the routing space 12. Note that the insertion direction of the dielectric 30 into the module accommodation chamber 11 is, for example, a forward direction and the direction intersecting the insertion direction is, for example, a downward direction. For example, the first wire 90 includes the first bent portion 91 for bending the first wire 90 downward. Note that a part of the first wire 90 from the rear end of the first terminal fitting 55A to the first bent portion 91 extends, for example, along the front-rear direction. The first wire 90 includes an obliquely extending portion 92. The obliquely extending portion 92 is a part extending obliquely to a front lower side toward an intermediate position in the front-rear direction of an expanded routing space 12A formed by the inner wall of a lower end part of the routing space 12. The first wire 90 includes a first lower bent portion 93 connected to the lower end of the obliquely extending portion 92. A part of the first wire 90 below the first lower bent portion 93 extends vertically downward. The first bent portion 91 is at an acute angle to the front-rear direction and extends downward. The first lower bent portion 93 is at an obtuse angle to the vertical direction and extends downward. In the routing space 12, each first wire 90 is arranged to the left of the second wires 100. In the routing space 12, the first wires 90 and the second wires 100 are routed while being spaced apart in the front-rear direction.

The second wires 100 extend one by one from the two second cavities 31 formed in the lower dielectric 35. The second wires 100 extending from the rear ends of the second terminal fittings 55B, i.e. extending from the rear ends of the second cavities 31, are drawn out into the routing space 12. The second wire 100 includes a second bent portion 101 bent in the same downward direction as the first wire 90. A part of the second wire 100 from the rear end of the second terminal fitting 55B to the second bent portion 101 extends, for example, along the front-rear direction. In a side view, the second wire 100 extends downward from the second bent portion 101. The two second wires 100 drawn out into the routing space 100 extend further downward from the second bent portions 101 and are bundled by having the outer peripheries collectively covered by the insulating sheath 25. The second bent portions 101 are exposed to outside without being covered by the sheath 25. The two second wires 100 are arranged to the right of the first wires 100.

The housing 20 includes the back surface cover 60 for closing the back surface. The back surface cover 60 includes a back surface flat plate portion 61 having a vertically long rectangular shape, plate-like back surface lock claws 62 extending forward from both left and right side surfaces of the back surface flat plate portion 61, and a rectangular partition wall 63 extending forward in a central part of the back surface flat plate portion 61. The back surface cover 60 is engaged with the housing 20 via the back surface lock claws 62. With the back surface cover 60 and the housing 20 engaged, the back surface flat plate portion 61 closes the back surface of the housing 20. With the back surface cover 60 and the housing 20 engaged, the front end of the partition wall 63 is in contact with the side surface of the sheath 25.

The housing 20 includes the lower surface cover 70 for closing the lower surface of the housing 20. The lower surface cover 70 includes a rectangular lower surface flat plate portion 71 and lower surface lock claws 72 extending upward from both left and right sides of the lower surface flat plate portion 71. The lower surface lock claws 72 are engaged with the lower lock receiving portions 15 of the housing 20 to be described later. The lower surface cover 70 includes a pair of coupling rods 73 extending upward from the lower surface flat plate portion 71 and to be coupled to the rubber plug 80 to be described later. The lower surface cover 70 includes a second guiding hole 74, through which the sheath 25 covering the two second wires 100 is inserted, on a right side when viewed from above. The lower surface cover 70 includes a pair of first guiding holes 75, through which the two first wires 90 are inserted, to the left of the second guiding hole 74.

The rubber plug 80 is arranged above the lower surface cover 70. The rubber plug 80 includes a pair of coupling holes 84. The lower surface cover 70 is coupled to the rubber plug 80 by press-fitting the pair of coupling rods 73 into the coupling holes 84. The rubber plug 80 has a rectangular shape with four rounded corners when viewed from above and includes a wavy convex-concave lip portion 81 on a side surface. As shown in FIG. 5, the rubber plug 80 is formed with a second sealing hole 82, through which the sheath 25 covering the second wires 100 is passed, on a right side when viewed from above. The rubber plug 80 includes a pair of first sealing holes 83, through which the two first wires 90 are inserted, to the left of the second sealing hole 82.

The annular front sealing ring 110 for sealing a fitting portion of the mating connector in a liquid-tight manner is fit on the outer periphery of the module accommodation chamber 11 of the housing 20. The annular back surface sealing ring 115 for sealing the back surface cover 60 in a liquid-tight manner is fit on the back side of the housing 20.

The connector 10 includes the front retainer 120 for laterally covering the plate-like portions 21 of the housing 20 and the terminal module 30A. The front retainer 120 is made of synthetic resin, covers the front surface of the housing 20 and functions to restrict the terminal module 30A from coming out forward and restrict the deflection of the plate-like portions 21.

The front retainer 120 includes a front surface flat plate portion 121 having a rectangular shape with four rounded corners and a cover peripheral wall 122 extending rearward from the peripheral edge of the front surface flat plate portion 121. The front surface flat plate portion 121 is formed with four openings 123 for allowing the insertion of the mating male terminals (not shown). Each of the four openings communicate with the insertion hole 43 of the lower dielectric 35.

### (Functions and Effects of Connector 10)

The connector 10 is assembled as follows. First, the coupling rods 73 of the lower surface cover 70 are inserted into the coupling holes 84 of the rubber plug 80 to couple the lower surface cover 70 and the rubber plug 80. At this time, the first guiding holes 75 and the first sealing holes 83 communicate. The second guiding hole 74 and the second sealing hole 82 communicate. Subsequently, the two first wires 90 are inserted through the first guiding holes 75 and the first sealing holes 83 from below. Subsequently, the sheath 25 covering the two second wires 100 is inserted through the second guiding hole 74 and the second sealing hole 82. At this time, the two first wires 90 are arranged to the left of the sheath 25. The two second wires 100 are twisted in parts covered by the sheath 25, whereby configuring a twisted pair cable.

Subsequently, the first terminal fittings 55A and the first wires 90, and the second terminal fitting 55B and the second wires 100 are respectively connected. By crimping the first crimping portions 56A to the front end parts of the first wires 90, the first terminal fittings 55A and the first wires 90 are connected. Simultaneously, by crimping the second crimping portions 56B to the front end parts of the second wires 100, the second terminal fittings 55B and the second wires 100 are connected.

Next, the terminal module 30A is assembled. As shown in FIG. 11, the second terminal fittings 55B are fit into the pair of second cavities 31 formed in the lower dielectric 35 from above. Specifically, the second terminal body portions 38 are accommodated into the second engaging recesses 39 formed in the bottom surfaces of the second cavities 31. Since vertical and horizontal widths of the second engaging recess 39 are substantially equal to those of the second terminal body portion 38, the second terminal body portion 38 is restricted from moving in the front-rear direction and lateral direction.

Further, the middle dielectric 45 is mounted from above on the lower dielectric 35 having the second terminal fittings 55B mounted therein. Specifically, the lower engaging portions 40 of the lower dielectric 35 and engaging portions (not shown) of the middle dielectric 45 are fit. Subsequently, the first terminal fittings 55A are accommodated into the pair of first cavities 46 formed in the middle dielectric 45. Specifically, the first positioning projections 45 formed on the first terminal body portion 57 are accommodated into the first positioning recesses 44 formed in the bottom surfaces of the first cavities 46. Since vertical and horizontal widths of the first engaging recess 44 are substantially equal to those of the first positioning projections 54, the first terminal body portion 57 is restricted from moving vertically and horizontally. Subsequently, the dielectric cover 65 is mounted on the middle dielectric 45 from above. Specifically, the dielectric cover 65 is fit to the middle dielectric 45 via the first engaging portions and fit to the lower dielectric 35 via the second engaging portions. In this way, the dielectric 30 holding the first terminal fittings 55A and the second terminal fittings 55B is formed.

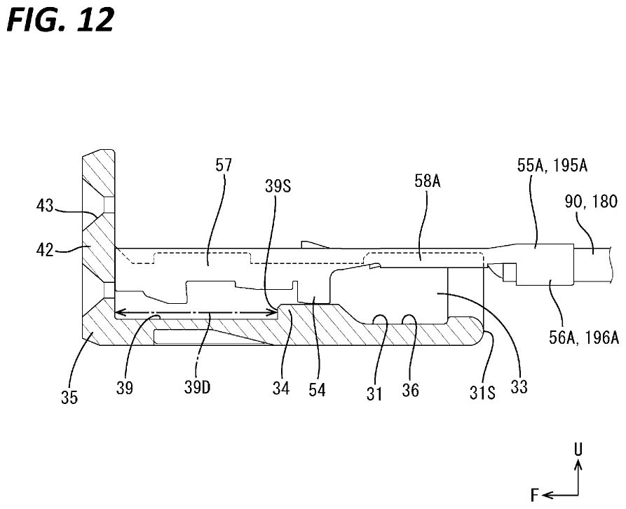

As shown in FIG. 12, if an attempt should be made to erroneously insert the first terminal fitting 55A into the second cavity 31 at the time of assembling the terminal module 30A, erroneous assembly can be easily detected since the second cavity 31 is shorter in the front-rear direction than the first terminal fitting 55A and the rear end of the first terminal fitting 55A protrudes from the rear end surface 31S of the second cavity 31.

Further, the length 39D in the front-rear direction of the second engaging recess 39 is shorter than a dimension in the front-rear direction from the front end of the first terminal body portion 57 to the first positioning projection 54 located on the rear end part of the first terminal body portion 57. Thus, in the case of the above erroneous assembly, the lower surface of the first positioning projection 54 comes into contact with the upper surface of the second projection 34. In this way, the first terminal body portion 57 of the first terminal fitting 55A is lifted without being accommodated into the second engaging recess 39 of the second cavity 31, wherefore the erroneous assembly can be easily detected.

Subsequently, as shown in FIG. 2, the terminal module 30A is assembled into the housing 20. The terminal module 30A is, for example, inserted into the routing space 12 through the lower surface opening 19. Thereafter, the dielectric 30 of the terminal module 30A is inserted into the module accommodation chamber 11 from behind the housing 20. As shown in FIG. 3, the dielectric 30 presses the inclined parts of the plate- like portions 21 from below by the front end surface of the inserting portion 42. The pressed plate-like portions 21 are resiliently deformed upward. If the lock portion 64 of the dielectric cover 65 rides over the front end surface 21S of the inclined part of the plate-like portion 21, the plate-like portion 21 is no longer pressed from below and is resiliently restored downward. At this time, the front end surface 21S of the inclined part of the plate-like portion 21 and the front end surface 64S of the lock portion 64 comes into contact to restrict movements in the front-rear direction. In this way, the dielectric 30 is accommodated into the module accommodation chamber 11 with movements restricted.

As shown in FIG. 3, at the time of inserting the dielectric 30 into the module accommodation chamber 11, the sheath end surface 25S comes into contact with the restricting surface 24S of the front wall portion 13 of the housing 20 to restrict an upward movement. Further, as shown in FIG. 4, movements of the second wires 100 in the front-rear rear direction are restricted by the restricting wall 29 of the path restricting portion 27. The sheath 25 is routed at a laterally right position at an intermediate position in the front-rear direction in the routing space 12. If the sheath 25 covering the two second wires 100 is arranged excessively forward in the routing space 12, a routing length (untwist length H) of the second wires 100 from the sheath end surface 25S to the second cavities 31 becomes long to degrade transmission characteristics. In the connector 10 of the present disclosure, the sheath 25 is arranged at an intermediate position in the front-rear direction of a lower end part of the routing space 12 in a plan view. Since this prevents the untwist length H of the second wires 100 between the end surface 25S of the sheath 25 and the rear ends of the second cavities 31 from becoming long, the degradation of transmission characteristics can be suppressed.

As shown in FIGS. 3 and 4, there is an interval D in the front-rear direction between the rear end surfaces 46S of the first cavities 46 of the dielectric 30 accommodated in the module accommodation chamber 11 and the rear end surfaces 31S of the second cavities 31. The second wires 100 are suppressed from extending further rearward than the first wires 90 by the side portions 52 and the lower portion 53. In this way, an interval is ensured in the front-rear direction between the first wires 90 bent behind the first cavities 46 and extending downward and the second wires 100 bent behind the second cavities 31 and extending downward. The transmission characteristics of the connector 100 are satisfactorily maintained by separating the first wires 90 and the second wires 100 in the front-rear direction. In a side view, a radius of curvature of the first bent portion 91 is larger than that of the second bent portion 101. In this way, a sufficient interval can be ensured in the front-rear direction between the first wires 90 and the second wires 100 in the routing space 12.

Subsequently, the front sealing ring 110 is mounted into the housing 20. The housing 20 and the fitting portion of the mating connector (not shown) are sealed in a liquid-tight manner by the front sealing ring 110.

Subsequently, the front retainer 120 is mounted into the housing 20 from front. The front retainer 120 secondarily retains the terminal fittings 55 by restricting the deflection of the plate-like portions 21.

Subsequently, the lower surface cover 70 is fit to close the lower surface opening 19 of the housing 20. Specifically, the lower surface lock claws 72 provided on the both side surfaces of the lower surface cover 70 and the lower lock receiving portions 15 of the housing 20 are fit. Further, by fitting the lower surface cover 70, the lip portion 81 of the rubber plug 80 is held in close contact with the inner wall of the housing 20 to prevent liquid intrusion from below. The end surface 25S of the sheath 25 inserted through the rubber plug 80 comes into contact with the restricting surface 24S of the routing space 12, whereby a vertical movement is restricted.

The obliquely extending portions 92 of the two first wires 90 drawn out from the rear ends of the first cavities 46 are curved obliquely forward while extending downward by the first bent portions 91, and extend toward an intermediate point in the front-rear direction of the lower end part of the routing space 12. In this way, the routing space 12 can be prevented from being enlarged rearward as compared to the case where the first wires 90 are caused to extend vertically downward by the first bent portions 91. The first wires 90 curved and extending obliquely forward are bent again to extend vertically downward from positions laterally spaced apart from the sheath 25 by the first lower bent portions 93. The first wires 90 and the sheath 25 are arranged apart from each other in the lateral direction. A certain interval is ensured in the lateral direction between the first wires 90 and the second wires 100. The connector 10 prevents the degradation of transmission characteristics by the interval in the lateral direction between the first wires 90 and the second wires 100.

Subsequently, the back surface cover 60 including the back surface sealing ring 115 is mounted. The back surface lock claws 62 of the back surface cover 60 and the upper lock receiving portions 16 of the connector 10 are engaged. The back side of the housing 20 is closed without any gap by the back surface sealing ring 115 arranged outside engaged locations, thereby having a waterproof function. The front end of the partition wall 63 comes into contact with the rear surface of the sheath 25, thereby restricting a rearward movement of the sheath 25. In the above way, the assembly of the connector 10 is completed.

The connector 10 of the first embodiment is provided with the housing 20 and the terminal module 30A. The housing 20 is formed with the module accommodation chamber 11 and the routing space 12 communicating with the rear end part of the module accommodation chamber 11. The terminal module 30A is inserted into the module accommodation chamber 11 from behind. The terminal module 30A includes the first wires 90, the first terminal fittings 55A fixed to the first wires 90, the second wires 100, the second terminal fittings 55B fixed to the second wires 100 and the dielectric 30 to be accommodated into the module accommodation chamber 11. The dielectric 30 includes the first cavities 46 for accommodating the first terminal fittings 55A and the second cavities 31 located below the first cavities 46 for accommodating the second terminal fittings 55B. The first wire 90 drawn out into the routing space 12 from the rear end of the first cavity 46 includes the first bent portion 91 by bending the tip part in the draw-out direction in the direction intersecting the insertion direction of the dielectric 30 into the module accommodation chamber 11 in the routing space 12. The second wire 100 drawn out into the routing space 12 from the rear end of the second cavity 31 includes the second bent portion 101 bent in the same direction as the first bent portion 91. The rear end of the first cavity 46 is located behind that of the second cavity 31.

Since the rear ends of the first cavities 46 are located behind the rear ends of the second cavities 31, the first wires 90 including the first bent portions 91 and the second wires 100 including the second bent portions 101 can be easily routed while being spaced apart in the front-rear direction. In this way, it is possible to suppress the degradation of transmission characteristics due to the approach of the first wires 90 and the second wires 100 in the housing 20.

The second cavity 31 of the first embodiment is preferably shorter in the front- rear direction of the first terminal fitting 55A.

According to this configuration, if an attempt is made to accommodate the first terminal fitting 55A into the second cavity 31, a part of the first terminal fitting 55A protrudes from the second cavity 31. Thus, the first terminal fitting 55A can be prevented from being erroneously accommodated into the second cavity 31.

The first wire 90 extends downward from the first bent portion 91 in the routing space 12. The second wire 100 extends from the second bent portion 101 in the same direction as the first bent portion 91 in the routing space 12. In the routing space 12, the first wires 90 and the second wires 100 are preferably routed while being spaced apart in the lateral direction.

According to this configuration, the first wires 90 and the second wires 100 are routed while being spaced apart not only in the front-rear direction, but also in the lateral direction. A large interval can be ensured between the first wires 90 and the second wires 100 in the routing space 12 as compared to the case where the first wires 90 and the second wires 100 are routed without being spaced apart in the lateral direction. Therefore, the degradation of transmission characteristics can be effectively suppressed even without increasing the dimension in the front-rear direction of the routing space 12.

The connector 10 is further provided with the resilient member 80 for closing an opening of an end part opposite to the module accommodation chamber 11 in the routing space 12. The resilient member 80 includes the first sealing holes 83, through which the first wires 90 are passed, and the second sealing hole 82, through which the second wires 100 are passed. The first sealing holes 83 and the second sealing hole 82 are preferably arranged apart from each other in the lateral direction.

According to this configuration, since the first wires 90 and the second wires 100 are held in such a positional relationship as to be laterally separated in the routing space 12 by inserting the first wires 90 and the second wires 100 through the first sealing holes 83 and the second sealing hole 82 of the resilient member 80, the degradation of transmission characteristics due to the approach of the first wires 90 and the second wires 100 is prevented.

### Second Embodiment

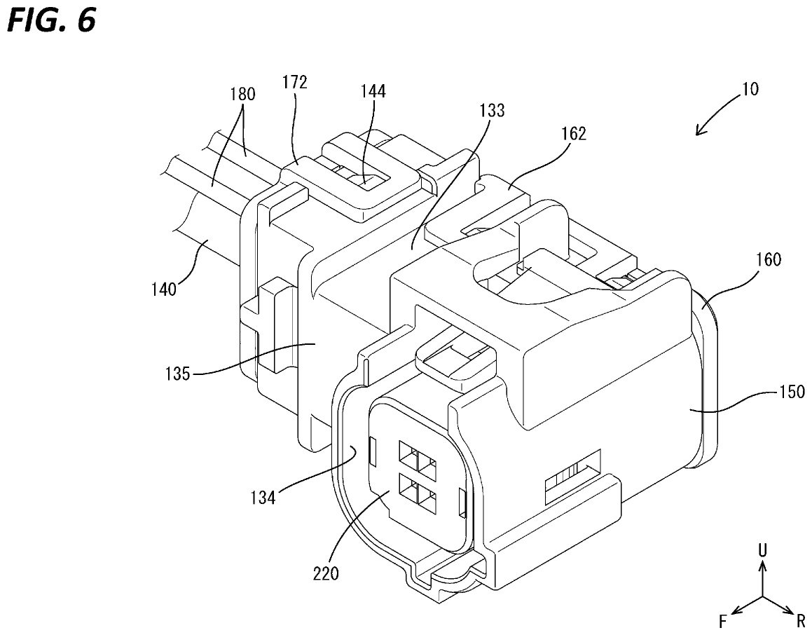

A connector 130 of a second specific embodiment of the present disclosure is described with reference to FIGS. 6 to 12. In the description of the second embodiment, the same components as in the first embodiment are not described and the same functions and effects as in the first embodiment are also not described.

### [Connector 130]

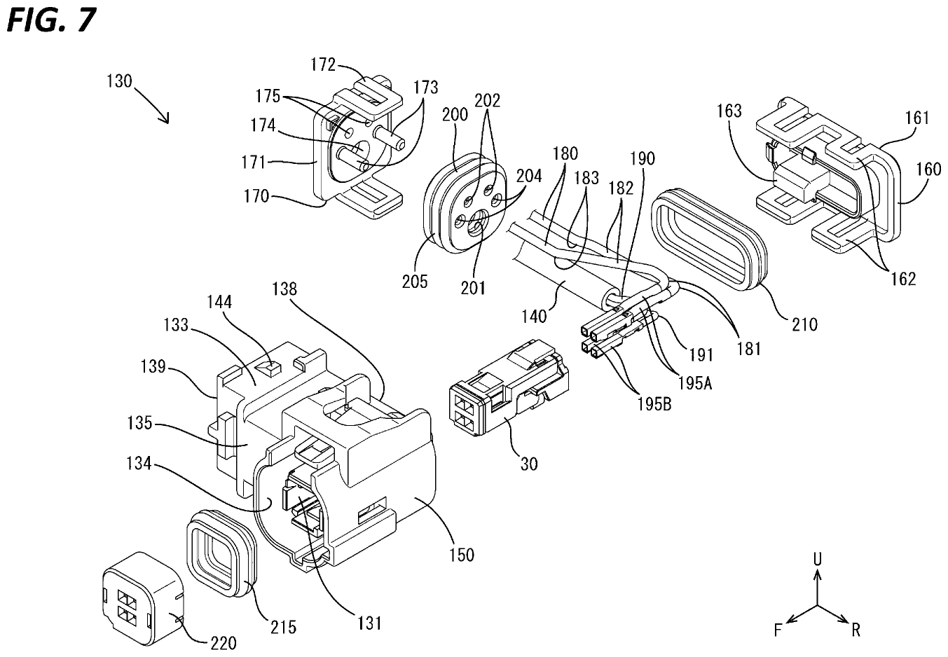

As shown in FIGS. 7 to 9, the connector 130 of the second embodiment is provided with a housing 150, a terminal module 30A, a back surface cover 160 for closing the housing 150 from a back side, a left surface cover 170 for closing the housing 150 from left, a rubber plug 200, a front sealing ring 215, a back surface sealing ring 210 and a front retainer 220. The housing 150 is L-shaped when viewed from above. A module accommodation chamber 131 extending in the front-rear direction and a routing space 132 extending leftward from a rear part of the module accommodation chamber 131 are formed in the housing 150. The outer surface of the housing 150 is covered by a front wall portion 135 and side wall portions 133. A front surface opening 134 is formed in the front surface of the housing 150. A back surface opening 138 is formed over an entire region of the back surface of the housing 150. A left surface opening 139 is formed in the left side surface of the housing 150.

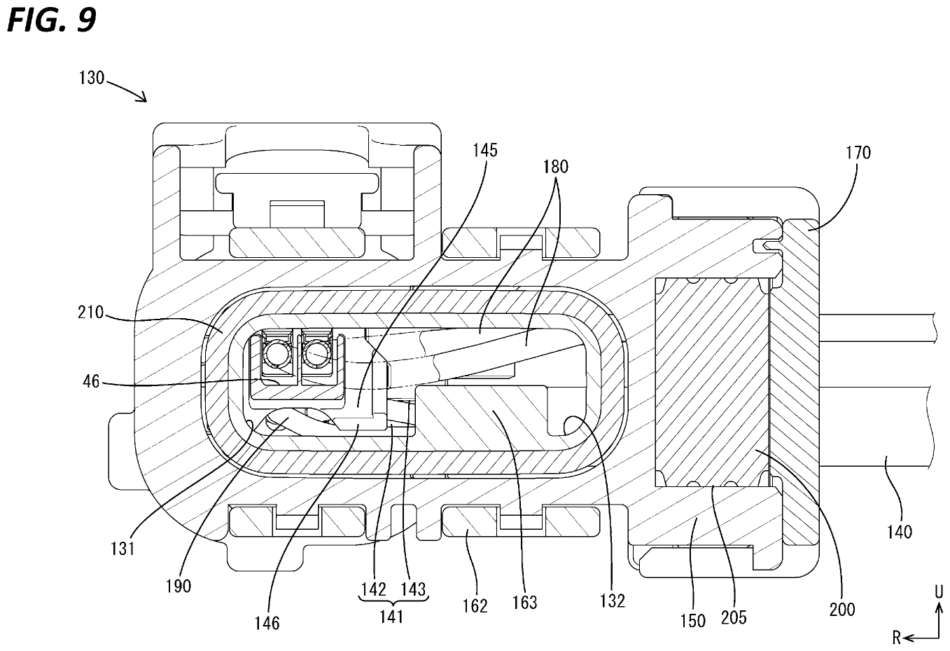

As shown in FIGS. 8 and 9, the routing space 132 is an internal space formed in the lateral direction in a rear part inside the housing 150. First wires 180 to be described later and front end regions of second wires 190 are accommodated in the routing space 12. The front wall portion 135 of the routing space 12 has an overhanging inclined surface 136 inclined to widen the routing space 132 in the front-rear direction toward a left side. The inclined surface 136 includes a recessed step portion 137 formed by a restricting surface 137S perpendicular to the lateral direction and a wall surface 136S perpendicular to the front-rear direction. The step portion 137 is formed by perpendicularly cutting the inclined surface 136. An end surface 140S of a sheath 140 of the second wires 190 is in contact with the restricting surface 137S of the step portion 137 perpendicular to the lateral direction. In a plan view of the housing 150, the step portion 137 is arranged at an intermediate position in the front-rear direction of the inner wall of a left end part of the routing space 132. As shown in FIG. 9, a path restricting portion 141 is formed on a right side of the lower part of the routing space 132. The path restricting portion 141 is defined by a guiding inclined surface 142 inclined forward toward the left and a pair of restricting walls 143 extending rearward from left and right edges of the guiding inclined surface 142.

The terminal module 30A of the second embodiment includes the first wires 180, first terminal fittings 195A, the second wires 190, the second terminal fittings 195B, and a dielectric 30. The first wire 180 is fixed to a first crimping portion 196A of the first terminal fitting 195A and extends in the routing space 132. As shown in FIG. 8, the first wire 180 includes a first bent portion 181 for bending the first wire 180 leftward. Note that, as shown in FIG. 7, a part of the first wire 180 from the rear end of the first terminal fitting 195A to the first bent portion 181 extends, for example, along the front-rear direction. As shown in FIG. 8, the first wire 180 includes an obliquely extending portion 182. The obliquely extending portion 182 is a part extending obliquely to a left front side toward a widthwise intermediate position in the front-rear direction of an expanded routing space 132A formed by the inner wall of a left end part of the routing space 132. The first wire 180 includes a first lateral bent portion 183. The first lateral bent portion 183 is connected to the lower end of the obliquely extending portion 182. A part of the first wire 180 below the first lateral bent portion 183 extends perpendicular to the left side. The first wires 180 extend one by one from two first cavities 46 formed in a middle dielectric 45. In the routing space 132, the respective first wires 180 are arranged above the second wires 190. The first wire 180 is bent to extend forward with respect to the perpendicular leftward direction by the first bent portion 181.

The second wire 190 is fixed to a second crimping portion 196B of the second terminal fitting 195B and extends in the routing space 132. The second wire 190 includes a second bent portion 191 bent in the same leftward direction as the first wire 180. Note that a part of the second wire 190 from the rear end of the second terminal fitting 195B to the second bent portion 191 extends, for example, along the front-rear direction. The second wire 190 extends from the second bent portion 191 substantially in the perpendicular leftward direction when viewed from below. The second wires 190 extend one by one from two second cavities 31 formed in a lower dielectric 35. The two second wires 190 drawn out into the routing space 132 extend further leftward from the second bent portions 191 and have the outer peripheries collectively covered by the insulating sheath 140. In the routing space 132, the two second wires 190 are arranged below the first wires 180. The first bent portion 181 bends the first wire 180 leftward at an acute angle to the front-rear direction. The first lateral bent portion 183 bends the first wire 180 leftward at an obtuse angle to the lateral direction.

The housing 150 includes the back surface cover 160 for closing the back surface. The back surface cover 160 includes a back surface flat plate portion 161 having a laterally long rectangular shape, back surface lock claws 162 extending forward from both upper and lower side surfaces of the back surface flat plate portion 161, and a rectangular partition wall 163 extending forward in a central part of the back surface flat plate portion 161. The back surface cover 160 is engaged with the housing 150 via the back surface lock claws 162. With the back surface cover 160 and the housing 150 engaged, the back surface flat plate portion 161 closes the back surface of the housing 150. With the back surface cover 160 and the housing 150 engaged, the front end of the partition wall 163 is in contact with the side surface of the sheath 140.

The housing 150 includes the left surface cover 170 for closing the left side surface of the housing 150. The left surface cover 170 includes a rectangular side surface flat plate portion 171 and left surface lock claws 172 extending rightward from both upper and lower side surfaces of the side surface flat plate portion 171. The left surface lock claws 172 are engaged with left lock receiving portions 144 of the housing 150 to be described later. The left surface cover 170 includes a pair of coupling rods 173 extending rightward from the side surface flat plate portions 171 and coupled to the rubber plug 200 to be described later. A second guiding hole 174, through which the sheath 140 covering the second wires 190 is inserted, is formed on a lower side of the left surface cover 170 when viewed laterally. A pair of first guiding holes 175, through which the two first wires 180 are inserted, are formed at positions above the second guiding hole 174 in the left surface cover 170.

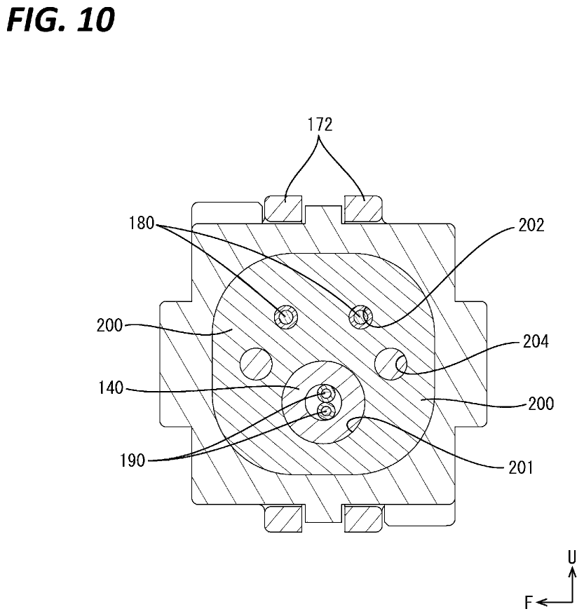

The rubber plug 200 is arranged to the right of the left surface cover 170. The rubber plug 200 includes a pair of coupling holes 204. The left surface cover 170 is coupled to the rubber plug 200 by press-fitting the pair of coupling rods 173 into the coupling holes 204. As shown in FIG. 10, a second sealing hole 201, through which the sheath 140 covering the second wires 190 is passed, is formed on a lower side of the rubber plug 200 when viewed laterally. The rubber plug 200 includes a pair of first sealing holes 202, through which the two first wires 180 are passed, above the second sealing hole 201.

### (Functions and Effects of Connector 130)

The connector 130 is assembled as follows. A step of inserting the first wires 180 and the second wires 190 through the sealing holes (201, 202), a step of crimping the terminal fittings (195A, 195B) to the wires (180, 190), a step of assembling the terminal module 30A, a step of mounting the front sealing ring 215, a step of mounting the front retainer 220 and a step of mounting the back surface cover 160 are similar to those in the first embodiment.

As shown in FIG. 7, the assembled terminal module 30A is assembled into the housing 150. In particular, the dielectric 30 of the terminal module 30A is inserted into the module accommodation chamber 131 from behind the housing 150. The dielectric 30 is accommodated into the module accommodation chamber 131 with movements restricted as in the first embodiment. As shown in FIG. 8, with the dielectric 30 accommodated in the module accommodation chamber 131, an interval D is formed in the front-rear direction between rear end surfaces 46S of the first cavities 46 and rear end surfaces 31S of the second cavities 31. In this way, the interval D in the front-rear direction is ensured between the first wires 180 bent and extending leftward from behind the second cavities 46 and the second wires 190 bent and extending leftward from behind the second cavities 31, wherefore the degradation of transmission characteristics can be suppressed.

The left surface cover 170 is fit to close the left surface opening 139 of the housing 150. Specifically, the left surface lock claws 172 provided on the both side surfaces of the left surface cover 170 and the left lock receiving portions 144 are fit. Further, by fitting the left surface cover 170, a lip portion 205 of the rubber plug 200 is held in close contact with the inner wall of the housing 150 to prevent liquid intrusion from left.

As shown in FIG. 9, the end surface 140S of the sheath 140 inserted through the rubber plug 200 is restricted from moving rightward by coming into contact with the restricting surface 137S of the routing space 132. If the sheath 140 covering the two second wires 190 is arranged excessively forward in the routing space 132, a routing length (untwist length H) of the second wires 190 from the sheath end surface 140S to the second cavities 31 becomes long to degrade transmission characteristics. In the connector 130 of the present disclosure, the sheath 140 is arranged at an intermediate position in the front-rear direction of a left end part of the routing space 132 when the housing 150 is viewed laterally. Since this prevents the routing length (untwist length H) of the second wires 190 between the sheath end surface 140S and the rear ends of the second cavities 31 from becoming long, the degradation of transmission characteristics can be suppressed.

As shown in FIG. 9, the two second wires 190 drawn out from the rear ends of the second cavities 31 are restricted to positions below the first wires 180 by the path restricting portion 141 formed in the lower part of the left side of the routing space 132. Immediately after the dielectric 30 is inserted into the module accommodation chamber 131, the second wires 190 protrude rearward from the rear ends of the side portions 145 of the middle dielectric 45. However, if the second wires 190 are pulled toward the path restricting portion 141, the second wires 190 protruding rearward from the rear ends of the side portions 145 of the middle dielectric 45 can be easily guided to positions in front of the side portions 145 and behind the guiding inclined surface 142 by the cover inclined surface 146. Then, the second wires 190 can be restricted to positions between the guiding inclined surface 142 and the side portions 145 in the front-rear direction. Further, since the side portions 145 are in the form of eaves covering the second wires 190 from behind, the second wires 190 are prevented from protruding rearward. In this way, the two first wires 180 drawn out from the rear ends of the first cavities 46 are arranged in front of and above the second wires 190.

As shown in FIG. 8, the interval D is provided in the front-rear direction between the rear end surfaces 46S of the first cavities 46 and the rear end surfaces 31S of the second cavities 31 of the dielectric 30 accommodated in the module accommodation chamber 131. The second wires 190 are suppressed from extending further rearward than the first wires 180 by the side portions 145 and a lower portion 147. In this way, an interval is ensured in the front-rear direction between the first wires 180 bent and extending leftward behind the first cavities 46 and the second wires 190 bent and extending leftward behind the second cavities 31. The transmission characteristics of the connector 130 are satisfactorily maintained by separating the first wires 180 and the second wires 190 in the front-rear direction. In a plan view, a radius of curvature of the first bent portion 181 is larger than that of the second bent portion 191. In this way, a sufficient interval can be ensured in the front-rear direction between the first wires 180 and the second wires 190 in the routing space 132.

As shown in FIG. 8, the obliquely extending portions 182 of the two first wires 180 drawn out from the rear ends of the first cavities 46 extend leftward while being curved forward by the first bent portions 181. The obliquely extending portion 182 extends from the first bent portion 181 to a widthwise intermediate position in the front- rear direction of the expanded routing space 132A formed by the inner wall of the left end part of the routing space 132. In this way, the routing space 132 can be prevented from being enlarged rearward as compared to the case where the first wires 180 are caused to extend perpendicularly leftward by the first bent portions 181.

The first wires 180 curved and extending obliquely forward are bent at positions vertically spaced apart from the sheath 140 by the first lateral bent portions 183. Further, the first wires 180 extend from the first lateral bent portions 183 leftward perpendicular to the front-rear direction in parallel to the sheath 140. The first wires 180 and the sheath 140 are arranged apart from each other in the vertical direction. A certain interval is ensured in the vertical direction between the first wires 180 and the second wires 190. The connector 130 prevents the degradation of transmission characteristics by the interval in the vertical direction between the first wires 180 and the second wires 190.

Subsequently, the back surface cover 160 including the back surface sealing ring 210 is mounted as in the first embodiment, whereby the assembly of the connector 130 is completed.

The connector 130 of the second embodiment is provided with the housing 150 and the terminal module 30A. The housing 150 is formed with the module accommodation chamber 131 and the routing space 132 communicating with the rear end part of the module accommodation chamber 131. The terminal module 30A is inserted into the module accommodation chamber 131 from behind. The terminal module 30A includes the first wires 180, the first terminal fittings 195A fixed to the first wires 180, the second wires 190, the second terminal fittings 195B fixed to the second wires 190 and the dielectric 30 to be accommodated into the module accommodation chamber 131. The dielectric 30 includes the first cavities 46 for accommodating the first terminal fittings 195A and the second cavities 31 located below the first cavities 46 for accommodating the second terminal fittings 195B. The first wire 180 drawn out into the routing space 132 from the rear end of the first cavity 46 includes the first bent portion 181 by bending the tip part in the draw-out direction in the direction intersecting the insertion direction of the dielectric 30 into the module accommodation chamber 131 in the routing space 132. The second wire 190 drawn out into the routing space 132 from the rear end of the second cavity 31 includes the second bent portion 191 bent in the same direction as the first bent portion 181. The rear end of the first cavity 46 is located behind that of the second cavity 31.

In the connector 130 of the second embodiment, the second cavity 31 is preferably shorter in the front-rear direction than the first terminal fitting 195A.

In the connector 130 of the second embodiment, the first wire 180 extends laterally from the first bent portion 181 in the routing space 132. The second wire 190 extends from the second bent portion 191 in the same direction as the first bent portion 181 in the routing space 132. In the routing space 132, the first wires 180 and the second wires 190 are routed while being spaced apart in the vertical direction.

According to this configuration, the first wires 180 and the second wires 190 are routed while being spaced apart not only in the front-rear direction, but also in the vertical direction. A large interval can be ensured between the first wires 180 and the second wires 190 in the routing space 132 as compared to the case where the first wires 180 and the second wires 190 are routed without being spaced apart in the vertical direction. Therefore, the degradation of transmission characteristics can be effectively suppressed even without increasing the dimension in the front-rear direction of the routing space 132.

The connector 130 of the second embodiment is further provided with the resilient member 200 for closing an opening of an end part opposite to the module accommodation chamber 131 in the routing space 132. The resilient member 200 includes the first sealing holes 202, through which the first wires 180 are passed, and the second sealing hole 201, through which the second wires 190 are passed. The first sealing holes 202 and the second sealing hole 202 are preferably arranged apart from each other in the vertical direction.

According to this configuration, since the first wires 180 and the second wires 190 are held in such a positional relationship as to be vertically separated in the routing space 132 by inserting the first wires 180 and the second wires 190 through the first sealing holes 202 and the second sealing hole 201 of the resilient member 200, the degradation of transmission characteristics due to the approach of the first wires 180 and the second wires 190 is prevented.

### Other Embodiments

(1) In the first and second embodiments, the second wire (100, 190) drawn out from the rear end of the second cavity 31 includes the second bent portion (101, 191) bent in the same direction as the first bent portion (91, 181). The same direction means that the direction of the second wire extending from the second bent portion toward a side opposite to the second terminal fitting and that of the first wire extending from the first bent portion to a side opposite to the first bent portion are the same in the vertical direction and lateral direction. The radius of curvatures of the first and second bent portions need not perfectly coincide.
(2) In the housing 150 of the second embodiment, the routing space 132 may extend rightward from behind the module accommodation chamber 131.
(3) Although the module accommodation chamber and the routing space communicate to configure the L-shaped housing 20, 150 in the first and second embodiments, the routing space may, for example, obliquely communicate with the module accommodation chamber.
(4) Although the dielectric 30 is composed of the lower dielectric 35, the middle dielectric 45 and the dielectric cover 65 in the first and second embodiments, the dielectric 30 may be composed only of a single component.
(5) Although the terminal module 30A accommodates a total of four terminal fittings in the first and second embodiments, three or less or five or more terminal fittings may be accommodated in a terminal module.
(6) The connector (10, 130) includes the rubber plug (80, 200) as the resilient member in the first and second embodiments. The resilient member used in the connector is not limited to the rubber plug and, for example, a synthetic resin may be used.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector, comprising:
a housing formed with a module accommodation chamber and a routing space communicating with a rear end part of the module accommodation chamber; and
a terminal module to be inserted into the module accommodation chamber from behind,
the terminal module including a first wire, a first terminal fitting fixed to the first wire, a second wire, a second terminal fitting fixed to the second wire and a dielectric to be accommodated into the module accommodation chamber,
the dielectric including a first cavity for accommodating the first terminal fitting and a second cavity located below the first cavity for accommodating the second terminal fitting,
the first wire drawn out into the routing space from a rear end of the first cavity including a first bent portion by bending a tip part in a draw-out direction in a direction intersecting an insertion direction of the dielectric into the module accommodation chamber in the routing space,
the second wire drawn out into the routing space from a rear end of the second cavity including a second bent portion bent in the same direction as the first bent portion, and
the rear end of the first cavity is located behind that of the second cavity.

2. The connector of claim 1, wherein the second cavity is shorter in a front-rear direction than the first terminal fitting.

3. The connector of claim 1, wherein:
the first wire extends downward from the first bent portion in the routing space,
the second wire extends from the second bent portion in the same direction as the first bent portion in the routing space, and
the first and second wires are routed while being spaced apart in a lateral direction in the routing space.

4. The connector of claim 3, further comprising a resilient member for closing an opening of an end part opposite to the module accommodation chamber in the routing space, wherein:
the resilient member includes a first sealing hole, the first wire being passed through the first sealing hole, and a second sealing hole, the second wire being passed through the second sealing hole, and
the first and second sealing holes are arranged at an interval from each other in the lateral direction.

5. The connector of claim 1, wherein:
the first wire laterally extends from the first bent portion in the routing space,
the second wire extends from the second bent portion in the same direction as the first bent portion in the routing space, and
the first and second wires are routed while being spaced apart in a vertical direction in the routing space.

6. The connector of claim 5, further comprising a resilient member for closing an opening of an end part opposite to the module accommodation chamber in the routing space, wherein:
the resilient member includes a first sealing hole, the first wire being passed through the first sealing hole, and a second sealing hole, the second wire being passed through the second sealing hole, and
the first and second sealing holes are arranged at an interval from each other in the vertical direction.
